(19) United States
(12) Patent Application Publication
(10) Pub. No.: US 2010/0088429 A1
(43) Pub. Date: Apr. 8, 2010

(54) METHOD FOR CONSTRUCTING A DECOMPOSITION DATA STRUCTURE OF MULTIPLE LEVELS OF DETAIL DESIGN FEATURE OF 3D CAD MODEL AND STREAMING THEREOF

(76) Inventors: Chih-Hsing CHU, Hsinchu (TW); Ping-Han WU, Hsinchu (TW); Yu-Hsuan CHAN, Hsinchu (TW); Mu-Chi SUNG, Hsinchu (TW)

Correspondence Address: Muncy, Geissler, Olds & Lowe, PLLC, P.O. BOX 1364, FAIRFAX, VA, 22038-1364, US

(21) Appl. No.: 12/203,778

(22) Filed: Sep. 3, 2008

(51) Int. Cl. G06F 15/16

(52) U.S. Cl. 709/246

(57) ABSTRACT

A method for streaming multi-LOD design feature of a 3D-CAD model comprises defining a LOD of a 3D-CAD model with each design feature of the 3D-CAD model, wherein the design feature is the smallest 3D-CAD model constructing unit; constructing the LOD of the 3D-CAD model into a decomposition data structure of LOD design feature recording each design feature of the 3D-CAD model in different LODs, wherein the LOD comprises all unit assembly faces of the design features; constructing a switch face display mechanism controlling whether each design feature of the 3D-CAD model is displayed; and encapsulating a designated design feature into a packet based on users' configuration and transmitting the packet. The invention achieves multi-tier real-time incremental streaming transmission and implements streaming transmission into point-to-point information sharing for collaborative participants to receive information from others to obtain higher level information and share information to others for integrated information sharing efficiency.

### BACKGROUND OF THE INVENTION

1. Field of the Invention

The present invention relates to a method for streaming a 3D CAD (computer-aided design) model, more particularly to a method for streaming multiple levels of detail (multi-LOD) design features of a 3D CAD model.

2. Description of the Prior Art

With the trend of economics globalization, participants of different phases in a product life cycle have to collaborate and cooperate through internet, and the “distributed product development mode” is thus formed. The product model is the core and most important information in the product life cycle; therefore, the extent of real-time, precision and security of sharing concerns the success of the distributed product development mode.

The product design data contains wide range of data types, including CAD (computer-aided design) files, design parameters, engineering attributes, geometric and topological information, etc. For whole product life cycle, the above-mentioned information, particularly the CAD files, plays a key role in particular phases and establishes communication between different phases. With the help of the visualized effect of CAD models, the collaborative participants of different phases can fast and precisely recognize as well as discuss common objects, and therefore more efficient communication and common agreement in design may be achieved.

But there have been some disadvantages in transmitting conventional 3D CAD models, particularly the transmission efficiency and convenience of data LOD (level of detail) operation. Because of the large file size of the 3D CAD model, some large and complex files can not be transmitted in single process even after compressed by computer. In addition, due to the current limit of network bandwidth, the rate of transmission for large files is quite slow and inefficient. Hence, the communication and operation among participants is severely impacted. On the other hand, for various roles of participants (e.g. processors of different parts) during the process of sharing the files to the multi-tier participants, various authorizing aspects to be understood should be configured. To achieve this goal, relevant users have to process the product aspects to be transmitted (e.g. deleting, hiding, or choosing partial components) and then proceed transmission; for another different participant, another adjustment with graphics software have to be proceeded again. It therefore causes the problem of time-costing and inconvenience in transmission.

Hence, to solve the above-mentioned problems of transmitting conventional 3D CAD models, it has been the target and direction for relevant enterprises to break through and develop a practical transmission method.

In view of this, after detailed investigation and design, the inventor, with experience in fabrication and design of relevant products, obtains the present invention to achieve the aforesaid objective.

### SUMMARY OF THE INVENTION

The objective of the present invention is to provide a method for streaming multiple levels of detail (multi-LOD) design feature of a 3D CAD model to solve the problem of inefficiency of conventional 3D CAD model transmission caused by large file size and inconvenience in data LOD operation.

The achieve the aforesaid objective, a method for streaming multi-LOD design feature of a 3D CAD model according to one embodiment of the present invention comprises:

a. defining a LOD of a 3D CAD model with each design feature of the 3D CAD model, wherein the design feature is the smallest unit for constructing the 3D CAD model;

b. constructing the LOD of the 3D CAD model into a decomposition data structure of LOD design feature recording each design feature of the 3D CAD model in different LODs, wherein the LOD comprises all unit assembly faces of the design features;

c. constructing a switch face display mechanism controlling whether each design feature of the 3D CAD model is displayed or not; and

d. encapsulating a designated design feature into a packet based on a user's configuration and transmitting the packet.

Another embodiment of the present invention discloses a method for constructing a decomposition data structure of LOD design feature, recording each design feature of a 3D CAD model with different LODs for streaming and/or authority control, comprising:

decomposing each design feature of the 3D CAD model into a plurality of unit assembly faces and recording the unit assembly faces in different LODs;

finding out the overlapped unit assembly faces, proceeding an intersection operation to obtain an intersection face, and proceeding a difference operation to obtain a difference face; and

recording the interdependent relationship between the unit assembly face and the intersection face and/or the difference face.

While comparing to prior art, the present invention accomplishes following advantages with the aforesaid methods:

1. to overcome the transmission limit of large CAD files due to insufficient network bandwidth.

2. ensuring the security of information sharing and providing appropriate transparency of information exchanging.

3. to function as an information tool for enterprises to implement resource planning in design chain.

4. to improve the efficiency of distributed collaborative operation system and enhancing the success rate for implementing collaborative operations.

5. to integrate with present information equipments, e.g. smart phone or platform for car electronics, via various transmitting techniques.

6. for collaborative participants, the above-mentioned method for streaming multi-LOD design features of 3D CAD model may control whether design features display or not via the switch face display mechanism to enhance the security of information transmission.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a three dimensional diagram showing one 3D CAD model of one embodiment of the present invention;

FIG. 2 is a diagram showing the correspondent decomposition data structure of LOD design feature of FIG. 1;

FIG. 3 is a three dimensional diagram showing another 3D CAD model of one embodiment of the present invention;

FIG. 4 is a three dimensional diagram showing the design feature of one embodiment of the present invention;

FIG. 5 is a diagram showing the overlapping switch face of one embodiment of the present invention;

FIG. 6 is a diagram showing the complete construction of the 3D CAD model of the present invention;

FIG. 7 is a three dimensional diagram showing a 3D model without design feature of one embodiment of the present invention;

FIG. 8 is a diagram showing the correspondent data structure diagram of FIG. 7;

FIG. 9 is a diagram showing the 3D model with one design feature of one embodiment of the present invention;

FIG. 10 is a diagram showing the 3D model with another design feature of one embodiment of the present invention;

FIG. 11 is a diagram showing the construction of the switch face display mechanism of one embodiment of the present invention;

FIG. 12 is a diagram showing the construction procedure of the switch face display mechanism of one embodiment of the present invention; and

FIG. 13 is schematic diagram showing the method for streaming the 3D CAD model of one embodiment of the present invention.

### DESCRIPTION OF THE PREFERRED EMBODIMENT

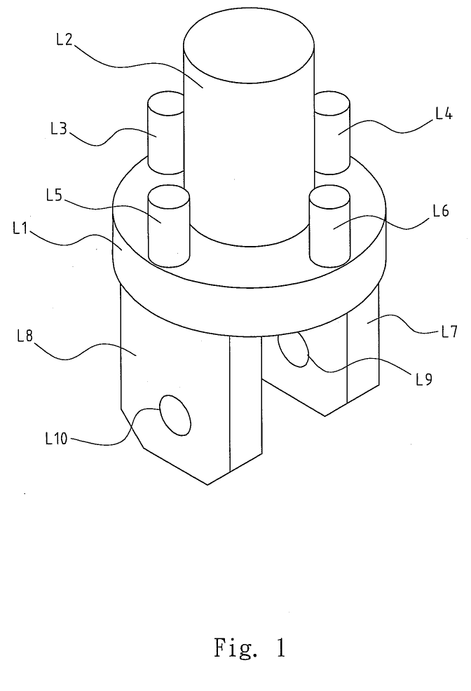

Refer to FIG. 1 to FIG. 13 showing the preferred embodiments according to the present invention. These embodiments are for illustrative purposes, and it is not thus limited in patent application. The present invention discloses a method for streaming multiple levels of detail (hereinafter abbreviated as multi-LOD) design feature of 3D CAD model, including:

a. defining a LOD of a 3D CAD model Lm with each design feature Vn of the 3D CAD model Lm, wherein the design feature Vn is the smallest unit for constructing the 3D CAD model Lm;

b. constructing the aforesaid LOD of the 3D CAD model into a decomposition data structure of LOD design feature 20 recording each design feature Vn of the 3D CAD model Lm in different LODs, wherein the LOD includes all unit assembly faces 21 of the design features;

c. Constructing a switch face display mechanism 30 controlling whether each design feature Vn of the 3D CAD model Lm is displayed or not;

d. encapsulating a designated design feature Vn into a packet based on a user's configuration and transmitting the packet.

In the above-mentioned embodiment, the design features Vn of the 3D CAD model Lm include a feature for increasing volume, e.g. a bulk, a cylinder, a barrel, a sheet, a sphere, or any combination of the above-mentioned, and/or a feature for decreasing volume, e.g. a groove, a hole, a hollow, a concavity, or any combination of the above-mentioned; and the switch face display mechanism 30 is achieved by choosing the difference of the features for increasing volume or the features for decreasing volume.

In addition, the above-mentioned method for streaming multi-LOD design feature of 3D CAD model further includes checking whether the each displayed design feature Vn of the 3D CAD model Lm is interdependent or not according to the decomposition data structure of LOD design feature, wherein the method for streaming multi-LOD design feature of 3D CAD model is calculated with an algorithm for constructing a multi-LOD model.

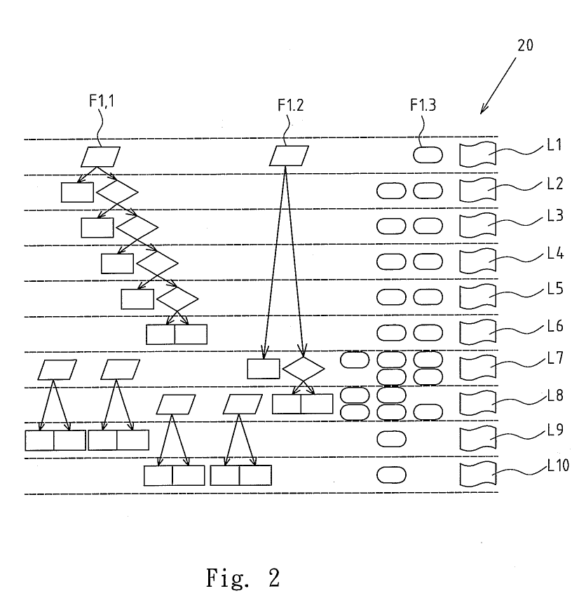

The usage status of the present invention is described as following. Briefly speaking, the method for streaming multi-LOD design feature of 3D CAD model makes a special processing on the 3D CAD model, based on the different requirements of collaborative developers, to present the content of design features with different details. The present invention is mainly based on the design features Vn recorded in the decomposition data structure of LOD design feature 20 (also referred as mesh decomposition tree, MDT) according to the grid data contained in the design features generated during modeling. FIG. 1 shows 3D CAD models L1˜L10 including ten design features Vn, in which the 3D CAD model L1 is constructed with a top face F1,1, a bottom face F1,2, and a side face F1,3. When the 3D CAD model L2 is next modeled, it requires the determination and calculation of the “algorithm for constructing multi-LOD model” to construct the 3D CAD model L2 and record the modeling process in different LODs. It is therefore the modeling of the 3D CAD models L3 to L10 is based on the above-mentioned method to form the correspondent decomposition data structure of LOD design feature 20 (shown in FIG. 2).

The algorithm for constructing multi-LOD model is a set of faces including all faces belonging to the m-th 3D CAD model, and different 3D CAD models (Lm and Lm+1) represent the existence of some design features Vn that are not shown in each other. That is, any 3D CAD model Lm has or lacks of information of certain faces while comparing to other 3D CAD model Lm. The design feature Vn represents the n-th design feature in the final 3D CAD model Lm, which is a set of faces recording all the faces constructing the design feature Vn.

For example, Fn b represent the b-th face of the n-th design feature. In the sequent algorithm, each 3D CAD model Lm and design feature would be converted to a set including Fn,b elelments, e.g. Va={Fa,0, Fa,1, . . . , Fa,b} or Li={Fi,0, Fi,1, . . . , Fi,b}. F(pq,rs) represents a set of faces generated from the difference operation of Fp,q and Fr,s , and Λm,n represents a set formed by the faces overlapping in the set of the 3D CAD model Lm and the design feature Vn, which is comprised of faces in pairs. [symbol] m,n and ⊖m,n represents the operation symbol of intersection and difference for Λm,n, respectively.

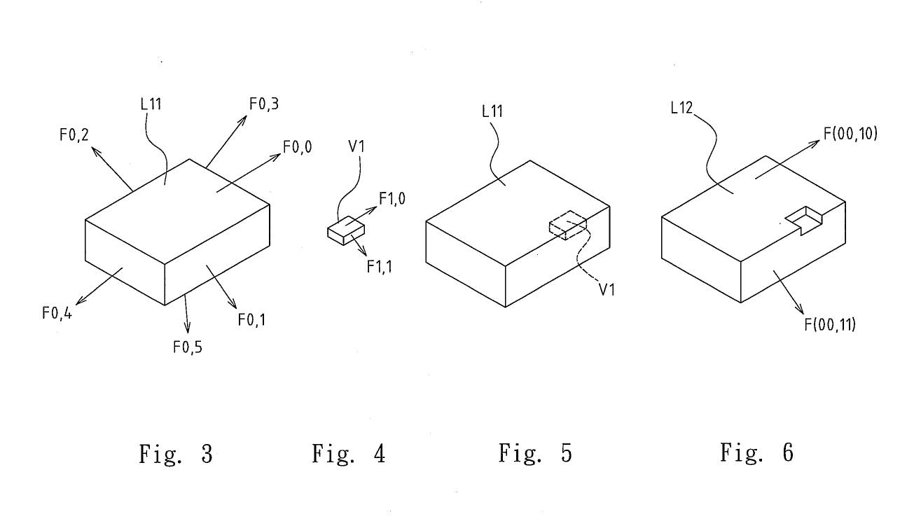

For example, as shown in FIG. 3, the 3D CAD model L11 is constructed with 6 faces including elements F0,0, F0,1, F0,2, F0,3, F0,4, and F0,5. When adding a design feature V1 (as shown in FIG. 4), the F1,0 and F1,1 would be face-overlapped with the F0,0 and F0,1 of the 3D CAD model L11(as shown in FIG. 5), and the set formed by two pairs of overlapping faces would beΛ0,1={(F0,0, F1,0), (F0,1, F1,1)}, the set of faces obtained from the face-intersection operation for the paired elements in theΛ0,1 would be [symbol] 0,1= [symbol] (Λ0,1)={F1,0, F1,1}, the set of faces obtained from the face-difference operation would be ⊖0,1=⊖(Λ0,1)={F(00,10), F(01,11)}, and [symbol] m,n represents the switch face. As shown in FIG. 3 to FIG. 6, if two switch faces F1,0, F1,1 and the 3D CAD model L12 show simultaneously, the design feature V1 will be capped in the view of computer graphics. The definition of the above-mentioned symbols is referred in Table 1.

TABLE 1
the definition of symbols of the algorithm

| Symbol | Definition |
|---|---|
| Lm | set of all faces in the m-th 3D CAD model |
| Vn | set of all faces of the n-th design feature |
| Fn, b | the b-th face of the design feature Vn |
| F(pq, rs) | the face obtained from the difference |
| | operation of Fp, q and Fr, s |
| Λm, n | set formed by faces overlapped in Lm and Vn |
| | set |
| [symbol] m, n | the face-intersection operation result of elements |
| | in Λm, n set |
| ⊖m, n | the face-difference operation result of elements |
| | in Λm, n set |

The detailed steps of the above-explained algorithm are defined as following:

(1) Define the 3D Lm having no added design feature Vn with faces defined by B-Rep data structure. As shown in FIG. 3, the 3D CAD model L11 has 6 faces {F0,0, F0,1, . . . , F0,5}. The following steps (2) to (5) calculate with repeated loops, and all design features Vn present in the final model would be processed with overlapping determination and 2D Boolean operation in the loop.

(2) when adding a design feature, as step (1), the design feature Vn is converted into a set of faces. As shown in FIG. 4, the set is design feature V1={F1,0, F1,1, . . . , F1,5}.

(3) Compare each face in the 3D CAD model Lm that has not added design feature Vn with each face in the design feature Vn in pairs to check if the faces overlap. If yes, the two overlapped faces are placed into the Λm,n set. As shown in FIG. 5, the (F0,0, F0,1) and (F1,0, F1,1) are face-overlapped; therefore the Λ0,1 comprises two elements, (F0,0, F1,0) and (F0,1, F1,1).

(4) Process the paired faces in Λm,n with Boolean operation of face-intersection and face-difference, and the obtained result is recorded into the [symbol] m,n and ⊖m,n. As shown in FIG. 3 to FIG. 6, [symbol] ,1={F1,0, F1,1}, and ⊖0,1={F(00,10), F(01,11)}.

(5) Delete the face-overlapped elements generated from the 3D CAD model Lm and design feature Vn sets, add the elements in ⊖m,n, and obtain all elements in next 3D CAD model Lm+1 set. It is therefore the 3D CAD model L12=[(L0uV1)−Λm,n]u⊖0,1={F0,2, F0,3, F0,4, F0,5, F1,2, F1,3, F1,4, F1,5, F(00,10), F(01,11)}, a set including 10 faces.

The algorithm for constructing a multi-LOD model is configured on the basis of 2D triangular grid; therefore each face is denoted with a particular code for distinguish the represented meaning thereof. The ID of each face includes 3 codes: the first code represents the hierarchy position of the unit assembly face in the decomposition data structure of LOD design feature 20 and also defines the belonged design features with the hierarchy position; the second code represents the index value recording the face number in the decomposition data structure of LOD design feature 20; the third code represents the core information of the face ID, given as five different attributes (1˜5) shown in Table 2.

TABLE 2
the definition of the third code of face ID

| Number | attribute |
|---|---|
| 1 | design feature Vn for increasing volume |
| 2 | design feature Vn for decreasing volume |
| 3 | temporary storage status |
| 4 | design feature Va representing the switch |
| | face of design feature Vn and for increasing |
| | volume |
| 5 | design feature Vb representing the switch |
| | face of design feature Vn and for decreasing |
| | volume |

TABLE 3
symbols in the decomposition data structure
of LOD design feature

| Symbol | Name | Meaning |
|---|---|---|
| 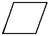 | root node | connects no node upward and connects a plurality of nodes downward |
| 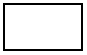 | leaf node | connects one node upward and connects no node downward |
| 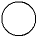 | independent node | connects no node upward and connects no node downward |
| 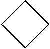 | temporary storage node | connects one node upward and connects at least one node downward |

In the following, the effect of decomposition data structure of LOD design feature 20 is explained with a simple example and illustrated with the correspondent algorithm.

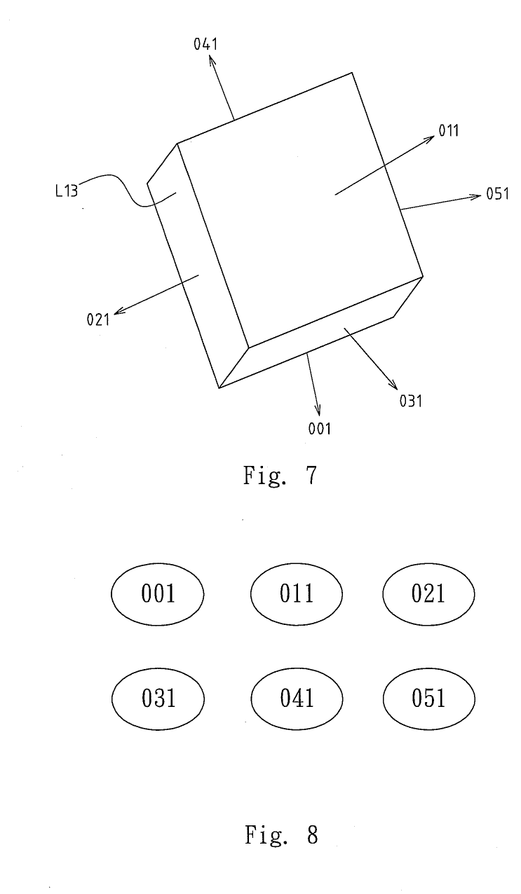

As shown in FIG. 7, the cubic 3D CAD model L13 consisted of 6 faces is denoted as 6 independent nodes (001, 011, 021, 031, 041, 051) in decomposition data structure of LOD design feature 20. FIG. 8 shows the correspondent data structure of the above-mentioned (hierarchy L13).

When a square groove design feature V2 is added into the 3D CAD model L13 (i.e. nodes 001˜051 shown in FIG. 8), there would be 3 overlapped faces 011, 021, and 031. As a result, the nodes 011, 021, and 031 would be decomposed into two sub-nodes, and the attributes of faces vary with adding square groove design feature V2 (referring to Table 2 and Table 3); therefore nodes 011, 021, and 031 become nodes 013, 023, and 033 (i.e. 011→013 represents the first index face at the zero hierarchy becomes attribute code 3 as temporary storage status due to the addition of design feature V2.), downward extended nodes 101, 104, nodes 111, 114, and nodes 121, 124 ( i.e. nodes 101, 104 represent the node 013 downward extending to two attribute feature face, where node 101 is the varied attribute feature face of original node 011, and node 104 is the attribute feature face after adding the square groove design feature V2), and the rest three independent nodes 132, 142, 152 that construct the square groove design feature V2.

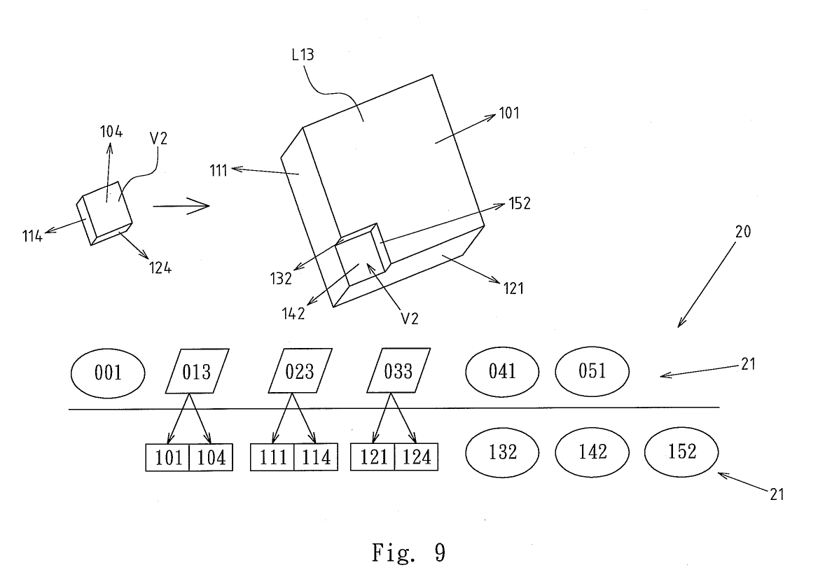

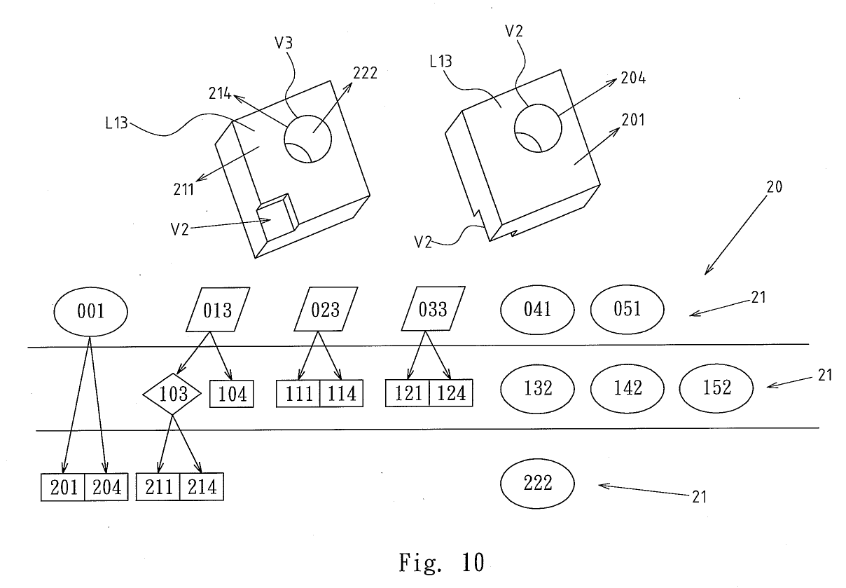

Next, add a round hole design feature V3 to the 3D CAD model L13 (i.e. the nodes 101˜152 shown in FIG. 9). According to the algorithm for constructing a multi-LOD model, determine if the face for constructing round hole design feature V3 overlaps with the faces in the 3D CAD model L13; if yes, two overlapped faces are placed into the set of Λ1,2 and processed with 2D planar Boolean operation to obtain the data structure diagram shown in FIG. 10. In the above-mentioned situation, two nodes 001 and 101 recorded in the 3D CAD model L13 are decomposed into two sub-nodes, in which one is the result of face-difference (201 and 211), and the other is the result of face-intersection (204 and 214), and node 222 represents the cylinder face that is used for constructing round hole design feature V3 and represents as the form of independent nodes.

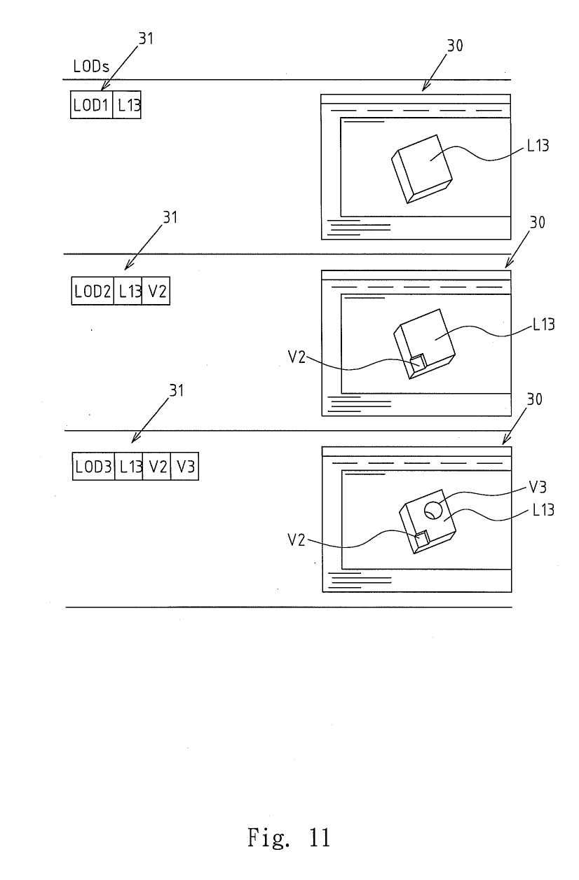

As shown in FIG. 11, the switch face display mechanism 30 finds out the correspondent data packet from the decomposition data structure of LOD design feature 20 based on selected displayed or hidden design feature Vn. The algorithm achieved with switch face display mechanism 30 is described as following:

(1) determine whether all design features (0,1, . . . , N) of the 3D CAD model Lm in each LOD display or not.

(2) If the design feature Vn is configured as hidden, proceed step (3); otherwise, proceed step (4); and at final store the required data packet into a display array.

(3) If the design feature Vn is configured as hidden, find out all nodes belonging to the design feature Vn (the face ID begins with N as its first code) from the decomposition data structure of LOD design feature 20, and then determine based on the last code of the face ID (referring to Table 2):

1. in case of 1 or 2, determine if it is an independent node; if yes, discard it, otherwise encapsulate the data packet of the node into the array.

2. in case of 3, determine if it is a root node; if yes, discard all nodes belonging to the node, otherwise discard the node.

3. in case of 4 or 5, store the data packet of the node into the array.

(4) if the design feature Vn is configured as displayed, find out all nodes belonging to the design feature Vn (the face ID begins with N as its first code) from the decomposition data structure of LOD design feature 20, and then determine based on the last code of the face ID (referring to Table 2):

1. in case of 1 or 2, store the data packet of the node into the array.

2. in case of 3, discard the node.

3. in case of 4 or 5, discard the node.

(5) at final, display all data packet stored in the display array via the built-in grid data, and obtain the 3D CAD model Lm with correspondent LOD.

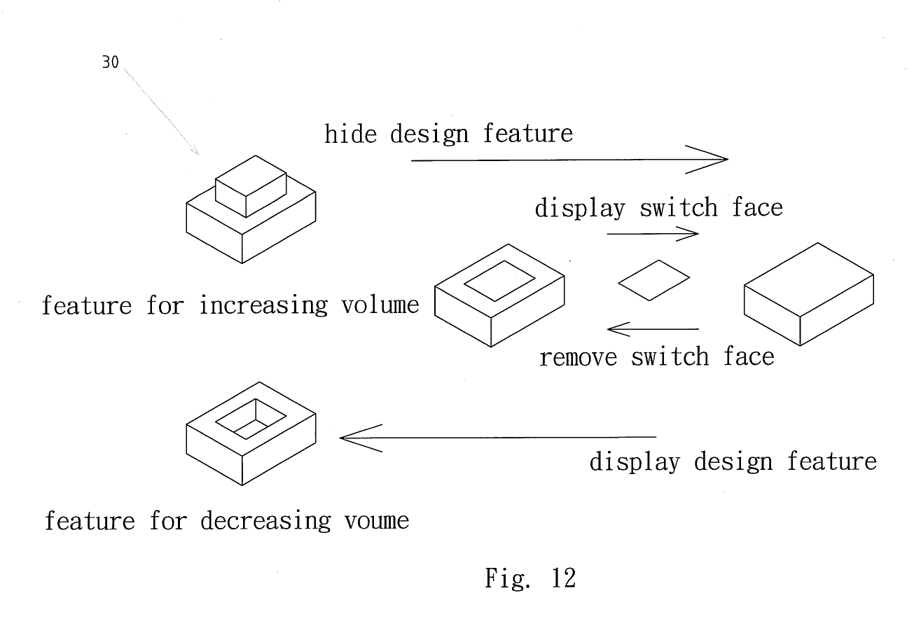

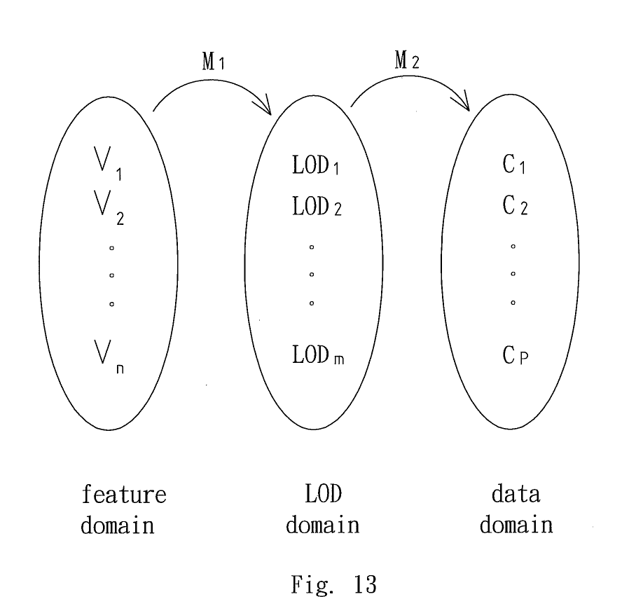

FIG. 12 shows the diagram illustrating the operation of the switch face display mechanism 30. To hide the feature for decreasing volume, it only needs removing the five faces constructing the square groove and displaying the switch face; on the other hand, the same principle and procedures may be adopted for the feature for increasing volume. In addition, each interdependent feature data structure 31 (as shown in FIG. 11) has been recorded in the decomposition data structure of LOD design feature 20 (as shown in FIG. 9 and FIG. 10), and the data search may be accelerated with predetermined code.

Hence, the method for generating complete multi-LOD 3D CAD model Lm is described as following: when design products with CAD software, the designer adds design features Vn during model construction and converts the design features Vn into the nodes in the decomposition data structure of LOD design feature 20 in a stepwise way to achieve the connection among nodes; therefore the correspondent decomposition data structure of LOD design feature 20 finishes as soon as the completion of the product design. Though the design feature Vn is sequential in the process of model construction, the model conversion among different hierarchies via switch face display mechanism 30 is not limited by the sequence of model construction. The only consideration would be the interdependent relation of design features for preventing the irrational 3D visual effect (e.g. floating, merohedral objects, and so on).

Refer to FIG. 13 showing the fundamental theory of the method for streaming (multi-LOD) design features of 3D CAD model. Briefly speaking, the streaming process can be defined as the best mapping among three information fields. The first domain is a feature domain including all design features. The second domain is a LOD domain including all 3D CAD models with different LODs, having a mapping relation with the first domain expressed as M1:f→Γ, and regarded as the symbol of business intelligence in distributed design defining the design information given to collaborative designers, wherein the generation of M1 is determined by product information owner with interface. The mapping relationship between the second and the third domain (data domain) maps between 3D CAD models with different LODs and real data blocks and is expressed as M2:Γ→C.

The present method may be practiced and developed as a form of independent software product or a plug-in application of present CAD software to finish the definition of decomposition data structure of LOD design feature as soon as the 3D CAD model construction is completed.

The streaming method of the present invention not only implements the one-to-one incremental transmission but also develops multi-tier real-time incremental streaming transmission for the requirement and feature of information sharing in the distributed collaborative environment of conventional distributed product development mode, that is, implementing streaming transmission into point-to-point product information sharing operation. In the collaborative platform for point-to-point streaming transmission, every collaborative participant is regarded as an independent individual to not only receive the product information from other individuals to obtain product information of higher level but also share product information to other individuals to achieve integrated information sharing efficiency. Hence the following advantages are achieved:
1. to overcome the transmission limit of large CAD files due to insufficient network bandwidth.
2. to ensuring the security of information sharing and providing appropriate transparency of information exchanging.
3. to functioning as an information tool for enterprises to implement resource planning in design chain.
4. to improve the efficiency of distributed collaborative operation system and enhancing the success rate for implementing collaborative operations.
5. to integrate with present information equipments, e.g. smart phone or platform for car electronics, via various transmitting techniques.
6. for collaborative participants, the above-mentioned method for streaming multi-LOD design features of 3D CAD model may control whether design features display or not via the switch face display mechanism to enhance the security of information transmission.

While the invention is susceptible to various modifications and alternative forms, a specific example thereof has been shown in the drawings and is herein described in detail. It should be understood, however, that the invention is not to be limited to the particular form disclosed, but to the contrary, the invention is to cover all modifications, equivalents, and alternatives falling within the spirit and scope of the appended claims.

What is claimed is:

1. A method for streaming multiple levels of detail (multi-LOD) design feature of a 3D CAD model, comprising:
defining a LOD of a 3D CAD model with each design feature of the 3D CAD model, wherein the design feature is the smallest unit for constructing the 3D CAD model;
constructing the LOD of the 3D CAD model into a decomposition data structure of LOD design feature recording each design feature of the 3D CAD model in different LODs, wherein the LOD comprises all unit assembly faces of the design features;
constructing a switch face display mechanism controlling whether each design feature of the 3D CAD model is displayed or not; and
encapsulating a designated design feature into a packet based on a user's configuration and transmitting the packet.

2. The method according to claim 1, wherein the design features of the 3D CAD model comprises features for increasing volume and/or features for decreasing volume.

3. The method according to claim 2, wherein the feature for increasing volume is a bulk, a cylinder, a barrel, a sheet, a sphere, or any combination of the above-mentioned.

4. The method according to claim 2, wherein the feature for decreasing volume is a groove, a hole, a hollow, a concavity, or any combination of the above-mentioned.

5. The method according to claim 1, wherein the switch face display mechanism is achieved by choosing the difference of the features for increasing volume or the features for decreasing volume.

6. The method according to claim 1, wherein the switch face is obtained by an intersection operation of correspondent faces overlapped in the design features.

7. The method according to claim 1, wherein the information recorded by the unit assembly face comprises a hierarchy position of the unit assembly face, an index value, and attributes of the unit assembly face.

8. The method according to claim 1 further comprising checking whether the each displayed design feature of the 3D CAD model is interdependent or not according to the decomposition data structure of LOD design feature.

9. A method for constructing a decomposition data structure of LOD design feature, recording each design feature of a 3D CAD model with different LODs for streaming and/or authority control, comprising:
decomposing each design feature of the 3D CAD model into a plurality of unit assembly faces and recording the unit assembly faces in different LODs;
finding out the overlapped unit assembly faces, proceeding an intersection operation to obtain an intersection face, and proceeding an difference operation to obtain an difference face; and
recording the interdependent relationship between the unit assembly face and the intersection face and/or the difference face.
